(19) United States
(12) Patent Application Publication
(10) Pub. No.: US 2025/0084909 A1
(43) Pub. Date: Mar. 13, 2025

(54) Sealing System and Method for Pressurized Sand Damper

(71) Applicant: Southern Methodist University, Dallas, TX (US)

(72) Inventor: Nikolaos Makris, Dallas, TX (US)

(21) Appl. No.: 18/823,052

(22) Filed: Sep. 3, 2024

Related U.S. Application Data
(60) Provisional application No. 63/581,371, filed on Sep. 8, 2023.

(51) Int. Cl. F16F 9/36; F16F 9/30; F16F 9/32

(52) U.S. Cl. CPC F16F 9/36; F16F 9/303; F16F 9/3221; F16F 9/3242; F16F 9/3271; F16F 2224/0208; F16F 2224/0291; F16F 2226/04; F16F 2230/30

(57) ABSTRACT

A leak-resistant pressurized granular-material damper comprising a supporting frame; a damper cylinder attached to the supporting frame and comprising a first piston opening at a first end of the damper cylinder and a second piston opening at a second end of the damper cylinder; a damper piston comprising first and second piston ends, wherein the damper piston is disposed on a damper cylinder longitudinal axis with the first piston end extending outward through the first piston opening and the second piston end extending through the second piston opening, with the damper piston is configured to move bidirectionally along the damper cylinder longitudinal axis; a damper sphere mounted on the damper piston in an interior of the damper cylinder; and one or more sealing ring assemblies, each sealing ring assembly disposed around the damper piston in the interior of the damper cylinder proximately to the first or the second piston opening.

### CROSS-REFERENCE TO RELATED APPLICATIONS

This application claims priority to U.S. Provisional Application Ser. No. 63/581,371, filed Sep. 8, 2023, the entire contents of which is incorporated herein by reference.

### STATEMENT OF FEDERALLY FUNDED RESEARCH

This invention was made with government support under CMMI-2036131 awarded by the National Science Foundation. The government has certain rights in the invention.

### TECHNICAL FIELD OF THE INVENTION

The present invention relates in general to pressurized dampers. In particular, the present invention relates to sealing systems and methods for pressurized sand dampers, or pressurized dampers that use either granular materials.

### BACKGROUND

Over the last 40 years, a variety of well-engineered structures which were designed according to building codes that were valid during their construction time, experienced severe damage worldwide during earthquake shaking. Most of this damage was the result of excessive seismic displacements, and many research programs were launched during the last four decades to study the seismic retrofit of civil structures. Improvements have been achieved in both design and analysis with the help of strong-motion records; while extensive retrofit programs have been implemented worldwide using the emerging response modification technologies (FHWA 1995; FEMA273 1997; FEMA356 2000; FEMA547 2006; ASCE/SEI 41-17 2017; Priestley et al. 1996).

The increasing need for structures to meet acceptable performance levels during earthquake and wind excitations has led to the development of various seismic and wind engineering design and retrofit strategies. In addition to seismic isolation (Kelly 1985, 1986; Buckle and Mayes 1990, Makris 2018), supplemental damping or strength/ductility-oriented design such as yielding steel dampers or buckling-restrained braces, are alternative strategies to the traditional seismic capacity design of structures (Kelly et al. 1972; Skinner et al. 1974; Robinson and Greenbank 1976; Soong and Dargush 1997; Constantinou et al. 1998; Black et al. 2002, 2003, 2004; Symans et al. 2008), where energy is dissipated in dedicated, specially designed energy dissipation devices. Supplemental energy dissipation has also been used extensively for the reduction of vibrations of buildings under wind loading (Davenport 1966; Kareem and Gurley 1996; McNamara et al. 1997; Kareem et al. 1999 among others).

One such strategy is the addition of fluid-dampers in an effort to limit excessive displacements. Fluid-dampers that generate fluid flow through orifices or valves were originally developed for the shock isolation of military hardware, and their technology was gradually transferred to civil applications in the 1980s. Currently, fluid-dampers of similar technology have been implemented in civil structures to suppress earthquake- and wind-induced vibrations. Given the appreciable differences in the frequency content, duration of loading, and stroke demands that are encountered in civil applications compared to military applications, there has been a number of experimental and analytical studies that examined the technology transfer and implementation of fluid-dampers in civil applications (Soong and Dargush 1997; Constantinou et al. 1998; Symans et al. 2008 and references reported therein). In buildings, fluid-dampers can be incorporated within the skeleton of the structure (Miyamoto and Scholl 1997), at the isolation level of a seismically isolated building (Asher et al. 1996; Constantinou et al. 1998), or in soft stories in buildings to control drifts (Kelly and Konstantinidis 2011; Youssef et al. 1995). At the same time, during the last 20 years, several bridges have been equipped with large-capacity fluid-dampers such as the 91/5 highway overcrossing (Delis et al. 1996; Makris and Zhang 2004), the San Francisco-Oakland Bay Bridge (Reno and Pohll 1998), the Rion-Antirion cable-stayed bridge (Papanikolas 2002), and the Richmond-San Rafael bridge (Dameron et al. 2003) among others.

The main challenge with fluid-dampers is whether they will maintain their long-term integrity when placed in civil structures which are subjected to a variety of loads, appreciable dynamic displacements, and long-term deformation patterns. Whereas large displacements and velocities are expected during earthquake loading, a prolonged wind loading would increase substantially the temperature of fluid-dampers. Early theoretical studies on the problem of viscous heating of fluid-dampers have been presented by Makris (1998) and Makris et al. (1998), which have been confirmed experimentally by Black and Makris (2006, 2007). Similar to wind loading, traffic loading on bridges induces vibrations of small amplitude; yet, very long duration that may fatigue the damper and eventually lead to catastrophic failure of the devices (Matier and Ross 2013). Potential failures of modem response modification technologies due to repeated loading are both disruptive and costly and certainly are orthogonal to the current trends for sustainable engineering, which in structural/earthquake engineering is understood as the design and construction of structural systems that meet acceptable performance levels at present and the years to come without compromising the ability of future generations to use them, maintain them and benefit from them.

An alternative strategy for the response modification of buildings is the use of buckling-restrained braces, which are yielding braces that increase the strength of the structure while offering supplemental hysteretic energy dissipation (Watanabe et al. 1988; Wada et al. 1989; Black et al. 2002, 2003, 2004; FEMA 547 2006). Because of their distributed yielding that leads to stable hysteretic behavior, buckling-restrained braces enjoy a worldwide acceptance, and they have been proven to be dependable response modification devices. Their hysteretic behavior originates from the yielding of their inner core; therefore, their displacement capacity is limited to the inelastic elongation of the steel inner core. Moreover, their pre-yielding elasticity stiffens the structure, and this may attract additional forces prior to yielding. Accordingly, buckling-restrained braces are suitable response modification devices for specific applications where the displacement demands are relatively small (few centimeters).

Motivated from the recent failures of fluid-dampers (failure of end-seals leading to detrimental leaking, Matier and Ross 2013) and the occasional displacement limitations of buckling-restrained braces, this disclosure presents the development of an innovative, low-cost, long-stroke, fail-safe energy dissipation device in which the material surrounding the moving piston and enclosed within the damper housing is pressurized sand. The proposed innovative pressurized sand-damper (PSD) encompasses the following unique advantages: (a) it does not suffer from the challenge of viscous heating and failure of its end-seals; while accommodating long strokes, (b) its symmetric force output is nearly velocity-independent given that the friction along the sand-steel interface is temperature independent, (c) it can be implemented in harsh environments with extreme high or low temperatures that may challenge the use of fluid-dampers, (d) its force output can be continuously monitored with standard, inexpensive strain gauges installed along the post-tensioned rods that exert the pressure on the sand; while the nominal pressure can be easily adjusted at will with additional post-tensioning; and (e) it is simple, stable, inexpensive and environmentally-friendly design meets the current trends for sustainable engineering. Part of the motivation for selecting sand as the dissipative material is because the dissipative performance of granular materials exhibits a minute dependence on temperature (Saeki 2005; Shah et al. 2009; Bannerman et al. 2011; Heckel et al. 2012; Sack et al. 2013).

The energy dissipation in the proposed pressurized sand-damper originates essentially from the shearing action of the pressurized sand (where shearing forces dominate over the inertia forces of the sand grains); therefore, the proposed concept is entirely different than the “piston-based particle damper” where the particles have a free-surface and energy dissipation originates primarily from the change in the momentum of the particles during multiple collisions (Masri 1969; Fowler et al. 2000; Bai et al. 2009; Shah et al. 2009; Lu et al. 2018). The proposed pressurized sand-damper exploits its pressure-dependent-strength of the yielding sand and its effect on increasing the dissipated energy during cyclic motion. An attractive advantage of the proposed pressurized sand-damper is that while it is a device that serves the modern philosophy of response modification, it consists only of traditional materials (sand and steel) in association with the use of post-tensioned steel rods with which practitioner civil engineers are most familiar.

One disadvantage of pressurized sand dampers is the possibility of leakage of sand. A system and method for preventing or reducing the leakage of pressurized sand from pressurized sand dampers is desirable. It is also desirable to provide a system and method for tuning a pressurized sand damper to a specified frequency.

### SUMMARY OF THE INVENTION

In one embodiment of the present invention, a leak-resistant granular-material damper includes a damper cylinder including a first piston opening at a first end of the damper cylinder and a second piston opening at a second end of the damper cylinder, the first and second piston openings disposed on a longitudinal axis of the damper cylinder; a damper piston including a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the damper piston in an interior of the damper cylinder, wherein a diameter of the damper sphere is less than an inner diameter of the damper cylinder; pressurized granular material filling the interior of the damper cylinder, wherein the pressurized granular material dissipates energy as the damper sphere moves with the damper piston along the longitudinal axis of the damper cylinder; and one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder. In one aspect, each of the one or more sealing ring assemblies is sized and disposed to tune the leak-resistant pressurized granular material damper to a selected frequency. In another aspect, the granular material is sand or ball bearings. In another aspect, each of the one or more sealing ring assemblies includes a cylindrical cap, wherein the cylindrical cap includes a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In another aspect, the cylindrical cap includes steel. In another aspect, the one or more sealing rings include PTFE. In another aspect, the one or more high-speed rod wipers include PTFE.

In another embodiment of the present invention, a sealing ring assembly includes a cylindrical cap, wherein the cylindrical cap includes a circular axial hole centered on the axis of the cylindrical cap, the circular axial hole having a piston portion having a first diameter to accommodate a damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In an aspect, the cylindrical cap includes steel. In another aspect, the one or more sealing rings include PTFE. In another aspect, the one or more high-speed rod wipers include PTFE.

In another embodiment of the present invention, a sealing ring assembly kit includes one or more sealing ring assemblies, each sealing ring assembly including a cylindrical cap, wherein the cylindrical cap includes a circular axial hole centered on the axis of the cylindrical cap, the circular axial hole having a piston portion having a first diameter to accommodate a damper piston, a sealing ring portion having a second diameter to accommodate one or more sealing rings, and a wiper portion having a third diameter to accommodate one or more high-speed rod wipers; the one or more sealing rings; and the one or more high-speed rod wipers; and a plurality of threaded fasteners to secure each sealing ring assembly to an interior surface of a damper cylinder of a pressurized granular-material damper. In an aspect, the cylindrical cap includes steel. In another aspect, the one or more sealing rings include PTFE. In another aspect, the one or more high-speed rod wipers include PTFE.

In another embodiment of the present invention, a method of preventing or reducing leaks of pressurized granular material from a pressurized granular-material damper includes providing a pressurized granular-material damper including a damper cylinder including a first piston opening at a first end of the damper cylinder and a second piston opening at a second end of the damper cylinder, the first and second piston openings disposed on a longitudinal axis of the damper cylinder; a damper piston including a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the damper piston in an interior of the damper cylinder, wherein a diameter of the damper sphere is less than an inner diameter of the damper cylinder; and pressurized granular material filling the interior of the damper cylinder, wherein the pressurized granular material dissipates energy as the damper sphere moves with the damper piston along the longitudinal axis of the damper cylinder; and disposing one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder. In an aspect, the method further includes sizing the one or more sealing ring assemblies to tune the pressurized granular-material damper to a selected frequency. In another aspect, the granular material is sand or ball bearings. In another aspect, each of the one or more sealing ring assemblies includes a cylindrical cap, wherein the cylindrical cap includes a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In another aspect, the cylindrical cap includes steel. In another aspect, the one or more sealing rings include PTFE. In another aspect, the one or more high-speed rod wipers include PTFE.

### BRIEF DESCRIPTION

For a more complete understanding of the features and advantages of the present invention, reference is now made to the detailed description of the invention along with the accompanying figures, in which:

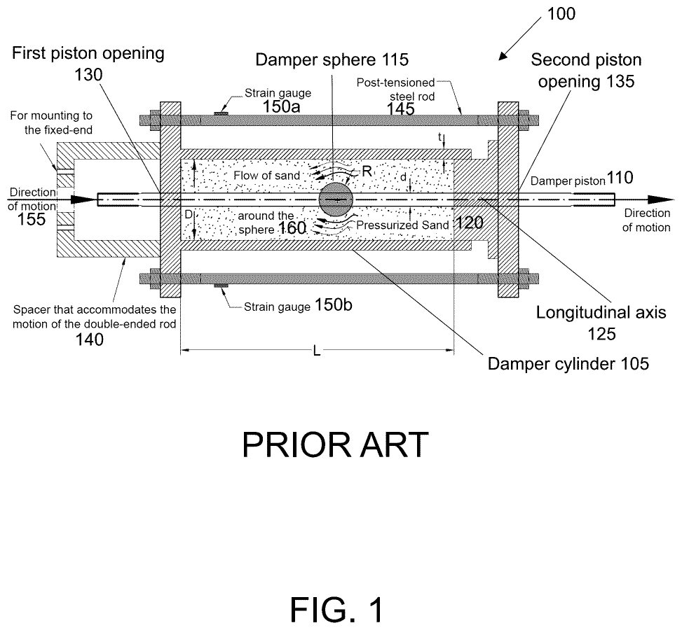

FIG. 1 shows a schematic view of a prior art pressurized sand damper.

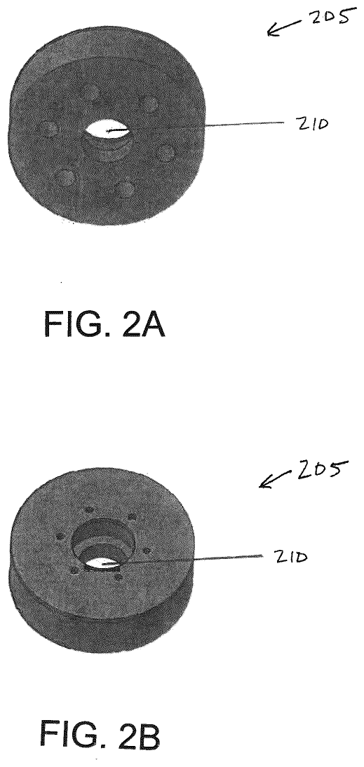

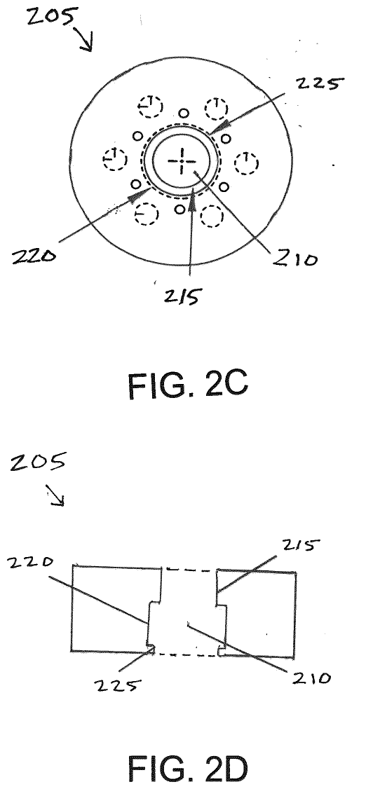

FIGS. 2A-2D show various views of a cylindrical cap of an embodiment of a sealing ring assembly.

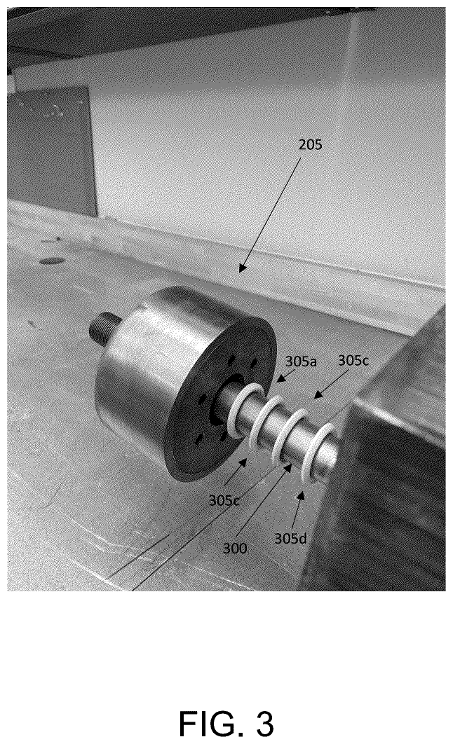

FIG. 3 shows the cylindrical cap mounted on a piston, on which four exemplary sealing rings are mounted before being press-fitted into the cylindrical cap.

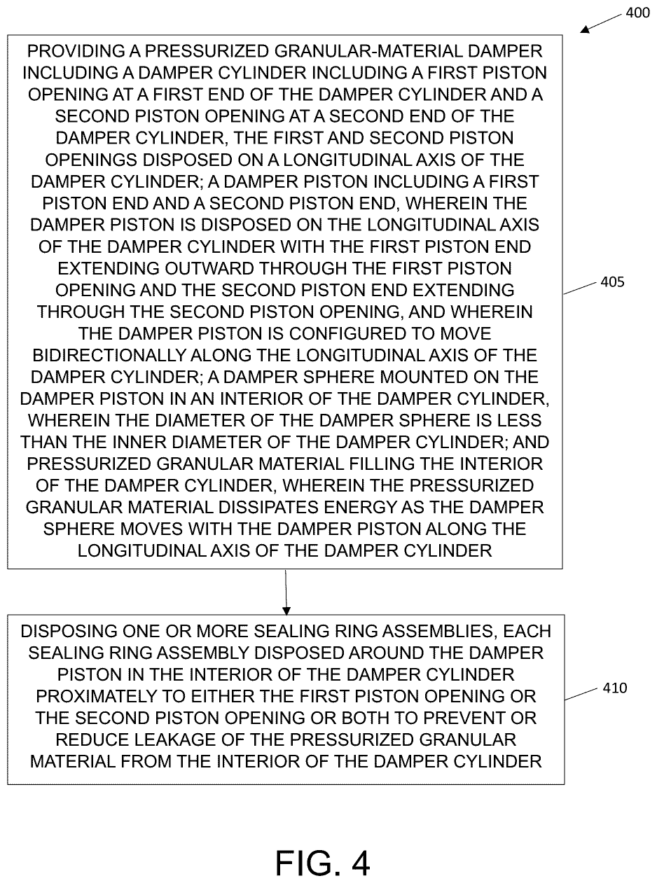

FIG. 4 shows a flowchart for a method embodiment of the present invention.

### DETAILED DESCRIPTION

While the making and using of various aspects of the present disclosure are discussed in detail below, it should be appreciated that the present disclosure provides many applicable inventive concepts that can be embodied in a wide variety of specific contexts. The specific aspects discussed herein are merely illustrative of specific ways to make and use the disclosure and do not delimit the scope of the disclosure.

To facilitate the understanding of this disclosure, a number of terms are defined below. Terms defined herein have meanings as commonly understood by a person of ordinary skill in the areas relevant to the present disclosure. Terms such as “a”, “an” and “the” are not intended to refer to only a singular entity, but include the general class of which a specific example may be used for illustration. The terminology herein is used to describe specific aspects of the disclosure, but their usage does not delimit the disclosure, except as outlined in the claims.

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

FIG. 1 shows a schematic view of a prior art pressurized sand damper 100. This prior art pressurized sand damper includes damper cylinder 105, damper piston 110, damper sphere 115, pressurized sand 120, a longitudinal axis of the pressurized cylinder 125, a first piston opening 130 in the pressurized cylinder 105, and a second piston opening 135 in the pressurized cylinder 105. In this pressurized sand damper 100, energy is dissipated from the shearing action of the pressurized sand 120 as the damper sphere 115 mounted on the damper piston 110 is plowing through the pressurized sand 120. FIG. 1 also shows a spacer 140 that accommodates the motion of the damper piston 110, a post-tensioned steel rod 145, and strain gauges 150a, 150b. One of two possible directions of motion 155 of the damper piston 110 is further shown, as well as the flow 160 of the pressurized sand 120 around the damper sphere 115 when the damper piston 110 moves in the direction of motion 155.

The present invention is based on the recognition that for the granular-material dampeners to be tunable, and robust, the flange(s) that retain the granular material (e.g., different size grains of sand, ball bearings, etc.), must not allow the material within the damper to leak. Further, the design must be able to withstand tens of thousands of cycles without failure. The ability to retain the dampening material is essential to the function of the damper because for the damper to be tunable, the pressure within the damper chamber must be maintained. Moreover, the plate mechanism must be of sufficient rigidity to not only withstand the thousands of cycles but also be able to compress the damper material without fatigue or breakage.

The present invention includes a sealing ring assembly and is designed for a pressurized granular-material damper including a damper cylinder comprising a first piston opening at a first end of the damper cylinder and a second piston opening at a second end of the damper cylinder, the first and second piston openings disposed on a longitudinal axis of the damper cylinder; a damper piston comprising a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the piston in an interior of the damper cylinder, wherein the diameter of the damper sphere is less than the inner diameter of the damper cylinder; and pressurized granular material filling the interior of the damper cylinder, wherein the pressurized granular material dissipates energy as the damper sphere moves with the damper piston along the longitudinal axis of the damper cylinder.

FIGS. 2A-2D show various views of a cylindrical cap 205 of an embodiment of a sealing ring assembly of the present invention. FIGS. 2A and 2B show exterior views of the cylindrical cap 205 with a circular axial hole 210 centered on the longitudinal axis of the cylindrical cap 205. FIG. 2C shows a top view of the cylindrical cap 205, and FIG. 2D shows a cross section of the cylindrical cap 205. The circular axial hole 210 has a piston portion 215 having a first diameter to accommodate the damper piston (not shown), a sealing ring portion 220 having a second diameter to accommodate one or more sealing rings (not shown), and a wiper portion 225 having a third diameter to accommodate a high-speed rod wiper (not shown). When the sealing ring assembly is secured in place in the pressurized granular-material damper, with the sealing ring or rings and the high-speed rod wiper in place within the circular axial hole and around the damper piston, the high-speed rod wiper or wipers and the sealing ring or rings work together to keep the pressurized granular material within the pressurized granular-material damper.

Some embodiments of the cylindrical cap are configured to be secured to an inner wall of the damper cylinder with threaded fasteners proximately to the first piston opening, the second piston opening, or both. The one or more sealing rings includes PTFE (polytetrafluoroethylene) or some other suitable sealing material. The one or more high-speed rod wipers comprises PTFE or some other suitable sealing material.

FIG. 3 shows the cylindrical cap 205 mounted on a piston 300, on which four exemplary sealing rings are mounted before being press-fitted into the sealing ring portion 220 (not shown) of the circular axial hole 210 (not shown). When press-fitted into the sealing ring portion 220, the sealing rings 305a-305d create a high-fidelity end-seal that has demonstrated successful sealing performance after more than 10,000 testing cycles.

FIG. 4 shows a flowchart for a method embodiment of the present invention. Method 400 includes Block 405, providing a pressurized granular-material damper including a damper cylinder including a first piston opening at a first end of the damper cylinder and a second piston opening at a second end of the damper cylinder, the first and second piston openings disposed on a longitudinal axis of the damper cylinder; a damper piston including a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the damper piston in an interior of the damper cylinder, wherein a diameter of the damper sphere is less than an inner diameter of the damper cylinder; and pressurized granular material filling the interior of the damper cylinder, wherein the pressurized granular material dissipates energy as the damper sphere moves with the damper piston along the longitudinal axis of the damper cylinder. Block 410 includes disposing one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder.

An embodiment of the present invention includes a sealing ring assembly kit including one or more sealing ring assemblies as described herein and a plurality of threaded fasteners to secure each sealing ring assembly to an interior surface of a damper cylinder of a pressurized granular-material damper.

An embodiment of the present invention includes a method of tuning the leak-resistant pressurized sand damper to a selected frequency. The method includes selecting a length, a diameter, or both of one or more sealing ring assemblies and disposing it within the pressurized sand damper as described herein.

In one embodiment of the present invention, a leak-resistant granular-material damper comprises, consists essentially of, or consists of a damper cylinder including a first piston opening at a first end of the damper cylinder and a second piston opening at a second end of the damper cylinder, the first and second piston openings disposed on a longitudinal axis of the damper cylinder; a damper piston including a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the damper piston in an interior of the damper cylinder, wherein a diameter of the damper sphere is less than an inner diameter of the damper cylinder; pressurized granular material filling the interior of the damper cylinder, wherein the pressurized granular material dissipates energy as the damper sphere moves with the damper piston along the longitudinal axis of the damper cylinder; and one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder. In one aspect, each of the one or more sealing ring assemblies is sized and disposed to tune the leak-resistant pressurized granular material damper to a selected frequency. In another aspect, the granular material is sand or ball bearings. In another aspect, each of the one or more sealing ring assemblies includes a cylindrical cap, wherein the cylindrical cap includes a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In another aspect, the cylindrical cap includes steel. In another aspect, the one or more sealing rings include PTFE. In another aspect, the one or more high-speed rod wipers include PTFE.

In another embodiment of the present invention, a sealing ring assembly comprises, consists essentially of, or consists of a cylindrical cap, wherein the cylindrical cap includes a circular axial hole centered on the axis of the cylindrical cap, the circular axial hole having a piston portion having a first diameter to accommodate a damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In an aspect, the cylindrical cap includes steel. In another aspect, the one or more sealing rings include PTFE. In another aspect, the one or more high-speed rod wipers include PTFE.

In another embodiment of the present invention, a sealing ring assembly kit comprises, consists essentially of, or consists of one or more sealing ring assemblies, each sealing ring assembly including a cylindrical cap, wherein the cylindrical cap includes a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers; the one or more sealing rings; and the one or more high-speed rod wipers; and a plurality of threaded fasteners to secure each sealing ring assembly to an interior surface of a damper cylinder of a pressurized granular-material damper. In an aspect, the cylindrical cap includes steel. In another aspect, the one or more sealing rings include PTFE. In another aspect, the one or more high-speed rod wipers include PTFE.

In another embodiment of the present invention, a method of preventing or reducing leaks of pressurized granular material from a pressurized granular-material damper comprises, consists essentially of, or consists of providing a pressurized granular-material damper including a damper cylinder including a first piston opening at a first end of the damper cylinder and a second piston opening at a second end of the damper cylinder, the first and second piston openings disposed on a longitudinal axis of the damper cylinder; a damper piston including a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder; a damper sphere mounted on the damper piston in an interior of the damper cylinder, wherein a diameter of the damper sphere is less than an inner diameter of the damper cylinder; and pressurized granular material filling the interior of the damper cylinder, wherein the pressurized granular material dissipates energy as the damper sphere moves with the damper piston along the longitudinal axis of the damper cylinder; and disposing one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder. In an aspect, the method further includes sizing the one or more sealing ring assemblies to tune the pressurized granular-material damper to a selected frequency. In another aspect, the granular material is sand or ball bearings. In another aspect, each of the one or more sealing ring assemblies includes a cylindrical cap, wherein the cylindrical cap includes a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers; the one or more sealing rings; and the one or more high-speed rod wipers. In another aspect, the cylindrical cap includes steel. In another aspect, the one or more sealing rings include PTFE. In another aspect, the one or more high-speed rod wipers include PTFE.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112(f) as it exists on the date of filing hereof unless the words “means for” or “step for” are explicitly used in the particular claim.

### REFERENCES

ASCE (American Society of Civil Engineers) 2017. ASCE Standard, ASCE/SEI, 41-17: Seismic Evaluation and Retrofit of Existing Buildings. Reston, VA.
Albert, I., Sample, J., Morss, A. J., Rajagopalan, S., Barabisi, A., and P. Schiffer. 2001. “Granular drag on a discrete object: Shape effects on jamming.” Physical Review E. 64(6): 061303.
Asher, J. W., Young, R. P., and R. D. Ewing. 1996. “Seismic isolation design of the San Bernardino County Medical Center replacement project.” J. Struct. Des. Tall Build. 5(4): 265-279.
Baber, T. T., and Y. K. Wen. 1981. “Random vibration of hysteretic degrading systems.” J. Eng. Mech, ASCE. 107(EM6), 1069-1087.
Baber, T. T., and M. N. Noori. 1985. “Random vibration of degrading, pinching systems.” J. Eng. Mech, ASCE. 111(8):1010-1026.
Bai, X. M., Shah, B., Keer, L. M., Wang, Q. J., and R. Q. Snurr. 2009. “Particle dynamics simulations of a piston-based particle damper.” J. Powder Technology. 189(1): 115-125.
Bannerman, M. N., Kollmer, J. E., Sack, A., Heckel, M., Mueller, P. and T. Poschel. 2011. “Movers and shakers: Granular damping in microgravity.” Physical Review E. 84(1): 011301.
Barenblatt, G. I. 1996. Scaling, self-similarity, and intermediate asymptotics: dimensional analysis and intermediate asymptotics. Cambridge University Press.
Black, C. J., Aiken, I. D., and N. Makris. 2002. “Component testing, stability analysis, and characterization of buckling-restrained unbounded Braces™.” Pacific Earthquake Engineering Research Center., College of Engineering, University of California, Berkeley.
Black, C. J., Makris, N., and I. D. Aiken. 2003. “Component testing and modeling of buckling restrained unbounded braces.” In Proc., Conference of Behavior of Steel Structure in Seismic Areas-Stessa. Naples, Italy.
Black, C. J., Makris, N., and I. D. Aiken. 2004. “Component testing seismic evaluation and characterization of buckling restrained braces.” J. Struct. Eng, ASCE. 130(6): 880-894.
Black, C. J., and N. Makris. 2006. “Viscous heating of fluid dampers under wind and seismic loading: experimental studies, mathematical modeling and design formulae.” Earthquake Engineering Research Center. University of California, Berkeley.
Black, C. J. and N. Makris. 2007. “Viscous heating of fluid dampers under small and large amplitude motions: experimental studies and parametric modeling.” J. Eng. Mech, ASCE. 133(5): 1210-1216.
Bouc, R. 1967. “Forced vibration of mechanical systems with hysteresis.” In Proc., 4th Conf on Non-Linear Oscillation. Prague, Czechoslovakia.
Bransby, M. F., Brown, M., Hatherley, A., and K. Lauder. 2010. “Pipeline plough performance in sand waves. Part 1: model testing.” Canadian Geotechnical. 47(1): 49-64.
Bransby, M. F., Barlow, D., Brown, M., Davidson, J., Brankin, S. and S. Robinson. 2018. “The performance of pipeline ploughs traversing seabed slopes.” Ocean Engineering., 148:125-135.
Buckle, I. G., and R. L. Mayes. 1990. “Seismic isolation: history, application, and performance-a world view.” J. Earthquake Spectra. 6(2): 161-201.
Cates, M. E, Wittmer, J. P., Bouchaud, J. P. and P. Claudin. 1998. “Jamming, force chains, and fragile matter.” Physical Review Letters. 81(9): 1841-1844.
Cates, M. E., Wittmer, J. P., Bouchaud, J. P., and P. Claudin. 1999. “Jamming and stress propagation in particulate matter.” Physica A. 263(1-4):354-361.
Charalampakis, A. E., and V. K. Koumousis. 2008. “On the response and dissipated energy of Bouc-Wen hysteretic model.” J. Sound Vib. 309(3-5):887-895.
Charalampakis, A. E. 2010. “Parameters of Bouc-Wen hysteretic model revisited.” In Proc., 9th HSTAM International Congress on Mechanics.
Constantinou, M. C., Soong, T. T., and G. F. Dargush. 1998. “Passive energy dissipation systems for structural design and retrofit.” Multidisciplinary Center for Earthquake Engineering Research, Buffalo, NY.
Constantinou, M. C., and M. A. Adnane. 1987. “Dynamics of soil-base-isolated-structure systems: evaluation of two models for yielding systems.” Report to the National Science Foundation. Department of Civil Engineering, Drexel University. Philadelphia, Pa.
Dameron, R. A., Parker, D. R., and T. Dahlgren. 2003. “Nonlinear time history analysis for the seismic retrofit of the Richmond-San Rafael bridge.” In Proc., 2nd MIT Conference on Computational Fuid and Solid Mechanics. 1(1): 212-216.
Davenport, A. G. 1966. “The treatment of wind loading on tall buildings.” Symposium on Tall Buildings. University of Southampton, England.
Delis, E. A., Malla, R. B., Madani, M., and K. J. Thompson. 1996. “Energy dissipation devices in bridges using hydraulic dampers.” In Struct Congr Proc, ASCE. New York, NY, USA.
FHWA (Federal Highway Administration). 1995. Seismic retrofitting manual for highway bridges. Publication No. FHWA-RD-94-052, McLean, Va.
FEMA (Federal Emergency Management Agency). 1997. NEHRP Guidelines for seismic rehabilitation of buildings. FEMA-273, Washington, D. C.
FEMA (Federal Emergency Management Agency). 2000. Pre-standard and commentary for the seismic rehabilitation of buildings. FEMA-356, Washington, D. C.
FEMA (Federal Emergency Management Agency). 2006. Techniques for the seismic rehabilitation of existing buildings. FEMA-547, Washington, D. C.
Fowler, B. L., Flint, E. M., and S. E. Olson. 2000. “Effectiveness and predictability of particle damping.” In Proc., SPIE Conference on Damping and Isolation. Newport Beach, CA.
Hardin, B. O., and V. P. Drnevich. 1972. “Shear modulus and damping in soil: measurement and parameter effects,” Soil Mechanics and Foundations Division. 98(6): 603-624.
Hardin, B. O., and V. P. Drnevich. 1972. “Shear modulus and damping in soil: design equations and curves.” Soil Mechanics and Foundations Division. 98(7):667-692.
Heckel, M., Sack, A., Kollmer, J. E. and T. POschel. 2012. “Granular dampers for the reduction of vibrations of an oscillatory saw.” Physica A. 391(19): 4442-4447.
Kareem, A., and K. Gurley. 1996. “Damping in structures: its evaluation and treatment of uncertainty.” J. Wind. Eng. & Indust. Aerodyn. 59(2):131-157.
Kareem, A., Kijewski, T., and Y. Tamura. 1999. “Mitigation of motions of tall buildings with specific examples of recent applications.” J. Wind and Struct. 2(3): 201-251.
Kelly, J. M., Skinner, R. I., and A. J. Heine. 1972. “Mechanisms of energy absorption in special devices for use in earthquake resistant structures.” Bulletin of NZ Society for Earthquake Engineering. 5(3):63-88.
Kelly, J. M. 1985. “Aseismic base isolation.” Shock Vib Digest., 17(7): 3-14.
Kelly, J. M., 1986. “Aseismic base isolation: review and bibliography.” J. Soil Dyn. and Earth. Eng. 5(4): 202-216.
Kelly, J. M, and D. Konstantinidis. 2011. “Mechanics of rubber bearings for seismic isolation and vibration isolation.” Wiley, Chichester, UK.
Langhaar, H. L. 1951. Dimensional analysis and theory of models. Wiley, New York.
Lauder, K. D., Brown, M. J., Bransby, M. F., and S. Boyes. 2012. “The influence of incorporating a forecutter on the performance of offshore pipeline ploughs.” Applied Ocean Research. 39(1):121-130.
Liu, A. J., and S. R. Nagel. 1998. “Jamming is not just cool any more.” Nature. 396(6706): 21-22.
Lu, Z., Wang, Z., Masri, S. F., and X. Lu. 2018. “Particle impact dampers: past, present, and future.” Struct Control Health Monit. 25(1): e2058.
Makris, N. 1998. “Viscous heating of fluid dampers I: small amplitude motions.” J. Eng. Mech, ASCE. 124(11): 1210-1216.
Makris, N. 2018. “Seismic isolation: Early history.” Earthquake Eng. Struct. Dyn., 48(2): 269-283.
Makris, N., and C. J. Black. 2003. “Dimensional analysis of inelastic structures subjected to near fault ground motions.” Earthquake Engineering Research Center, University of California, Berkeley, CA.
Makris N., and C. J. Black. 2003. “Dimensional analysis of rigid-plastic and elastoplastic structures under pulse-type excitations.” J. Eng. Mech, ASCE. 130(9):1006-1018.
Makris, N., Roussos, Y., Whittaker, A. S., and J. M. Kelly. 1998. “Viscous heating of fluid dampers II: large-amplitude motions.” J. Eng. Mech, ASCE. 124(11):1217-1223.
Makris, N., and J. Zhang. 2004. “Seismic response analysis of highway overcrossings equipped with elastomeric bearings and fluid dampers.” J. Struct. Eng, ASCE. 130(6): 830-845.
Masri, S. F. 1969. “Analytical and experimental studies of multiple impact dampers.” J. Acoust. Soc. Am. 45(5): 1111-1117.
Matier, P., and A. Ross. 2013. “Bay bridge shock absorbers spring leak.” San Francisco Chronicle, San Francisco Bay Area, CA.
McNamara, R., Boggs, D., Lai, M., Makris, N., Nielsen, E., and J. Cermak. 1997. “Tailoring of damping in structures: design issues.” In Proc., Building to Last, ASCE. Portland, OR.
Miyamoto, H. K., and R. E. Scholl. 1997. “Design of steel pyramid using seismic dampers.” In Proc., Building to Last, ASCE. Portland, OR.
Papanikolas, P. K. 2002. “Deck superstructure and cable stays of the Rion-Antirion bridge.” In Proc., 4th National Conference on Steel Structures, Patras, Greece.
Priestley, M., Seible, F., and G. Calvi. 1996. “Seismic design and retrofit of bridges.” Wiley, New York.
Reno, M. L., and M. Pohll. 1998. “Seismic retrofit of San Francisco-Oakland Bay bridge west crossing.” J. Transp. Res. Rec. 1624(1): 73-81.
Robinson, W., and L. Greenbank. 1976. “An extrusion energy absorber suitable for the protection of structures during an earthquake.” Earthquake Eng. Struct. Dyn. 4(3):251-259.
Sack, A., Heckel, M., Kollmer, J. E., Zimber, F. and T. POschel. 2013. “Energy dissipation in driven granular matter in the absence of gravity.” Physical Review Letters. 111(1): 018001.
Saeki, M., 2005. “Analytical study of multi-particle damping.” J. Sound Vib. 281(3-5):1133-1144.
Shah, B., Pillet, D., Bai, X., Keer, L., Wang, Q., and R. Snurr. 2009. “Construction and characterization of a particle-based thrust damping system.” J. Sound Vib. 326(3-5): 489-502.
Skinner, R. I., Kelly, J. M., and A. J. Heine. 1974. “Hysteretic dampers for earthquake-resistant structures.” Earthquake Eng. Struct. Dyn. 3(3):287-296.
Soong, T. T., and G. F. Dargush. 1997. Passive energy dissipation systems in structural engineering. Willey.
Sues, R. H., Mau, S. T., and Y. K. Wen. 1988. “Systems identification of degrading hysteretic restoring forces.” J. Eng. Mech, ASCE. 114(5):833-846.
Symans, M. D., Charney, F. A., Whittaker, A. S., Constantinou, M. C., Kircher, C. A., Johnson, M. W., and R. J. McNamara. 2008. “Energy dissipation systems for seismic applications: current practice and recent developments.” J. Struct. Eng, ASCE. 134(1): 3-21.
Wada, A., Saeki, E., Takeuch, T., and A. Watanabe. 1989. “Development of unbonded brace.” Column Technical Publication No. 1151989.12. Nippon Steel, Japan.
Watanabe, A., Hitomoi, Y., Saeki, E., Wada, A., and M. Fujimoto. 1988. “Properties of braces encased in buckling-restraining concrete and steel tube.” In Proc., 9th World Conf on Earthquake Engineering, Japan.
Wen, Y. K. 1975. “Approximate method for nonlinear vibration.” J. Eng. Mech, ASCE. 101(4): 389-401.
Youssef, N., Nuttall, B., Rahman, A., and O. Tahtakran. 1995. “The role of reinforced concrete in the stiffening and strengthening above base isolation for a tall historic landmark: Los Angeles City Hall.” In Proc., 3^{rd} National Concrete and Masonry Engineering conference, San Francisco, CA.

What is claimed is:

1. A leak-resistant pressurized granular-material damper comprising:
a damper cylinder comprising a first piston opening at a first end of the damper cylinder and a second piston opening at a second end of the damper cylinder, the first and second piston openings disposed on a longitudinal axis of the damper cylinder;
a damper piston comprising a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder;
a damper sphere mounted on the damper piston in an interior of the damper cylinder, wherein a diameter of the damper sphere is less than an inner diameter of the damper cylinder;
pressurized granular material filling the interior of the damper cylinder, wherein the pressurized granular material dissipates energy as the damper sphere moves with the damper piston along the longitudinal axis of the damper cylinder; and
one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder.

2. The leak-resistant pressurized granular-material damper of claim 1, wherein each of the one or more sealing ring assemblies is sized and disposed to tune the leak-resistant pressurized granular material damper to a selected frequency.

3. The leak-resistant pressurized granular-material damper of claim 1, wherein the granular material is sand or ball bearings.

4. The leak-resistant pressurized granular-material damper of claim 1, wherein each of the one or more sealing ring assemblies comprises:
a cylindrical cap, wherein the cylindrical cap comprises a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers;
the one or more sealing rings; and
the one or more high-speed rod wipers.

5. The leak-resistant pressurized granular-material damper of claim 4, wherein the cylindrical cap comprises steel.

6. The leak-resistant pressurized granular-material damper of claim 4, wherein the one or more sealing rings comprise PTFE.

7. The leak-resistant pressurized granular-material damper of claim 4, wherein the one or more high-speed rod wipers comprise PTFE.

8. A sealing ring assembly comprising:
a cylindrical cap, wherein the cylindrical cap comprises a circular axial hole centered on the axis of the cylindrical cap, the circular axial hole having a piston portion having a first diameter to accommodate a damper piston, a sealing ring portion having a second diameter to accommodate one or more sealing rings, and a wiper portion having a third diameter to accommodate one or more high-speed rod wipers;
the one or more sealing rings; and
the one or more high-speed rod wipers.

9. The sealing ring assembly of claim 8, wherein the cylindrical cap comprises steel.

10. The sealing ring assembly of claim 8, wherein the one or more sealing rings comprise PTFE.

11. The sealing ring assembly of claim 8, wherein the one or more high-speed rod wipers comprise PTFE.

12. A sealing ring assembly kit comprising:
one or more sealing ring assemblies, each sealing ring assembly comprising:
a cylindrical cap, wherein the cylindrical cap comprises a circular axial hole centered on the axis of the cylindrical cap, the circular axial hole having a piston portion having a first diameter to accommodate a damper piston, a sealing ring portion having a second diameter to accommodate one or more sealing rings, and a wiper portion having a third diameter to accommodate one or more high-speed rod wipers;
the one or more sealing rings; and
the one or more high-speed rod wipers; and
a plurality of threaded fasteners to secure each sealing ring assembly to an interior surface of a damper cylinder of a pressurized granular-material damper.

13. The kit of claim 12, wherein the cylindrical cap comprises steel.

14. The kit of claim 12, wherein the one or more sealing rings comprise PTFE.

15. The kit of claim 12, wherein the one or more high-speed rod wipers comprise PTFE.

16. A method of preventing or reducing leaks of pressurized granular material from a pressurized granular-material damper, comprising:
providing a pressurized granular-material damper comprising:
a damper cylinder comprising a first piston opening at a first end of the damper cylinder and a second piston opening at a second end of the damper cylinder, the first and second piston openings disposed on a longitudinal axis of the damper cylinder;
a damper piston comprising a first piston end and a second piston end, wherein the damper piston is disposed on the longitudinal axis of the damper cylinder with the first piston end extending outward through the first piston opening and the second piston end extending through the second piston opening, and wherein the damper piston is configured to move bidirectionally along the longitudinal axis of the damper cylinder;
a damper sphere mounted on the damper piston in an interior of the damper cylinder, wherein a diameter of the damper sphere is less than an inner diameter of the damper cylinder; and
pressurized granular material filling the interior of the damper cylinder, wherein the pressurized granular material dissipates energy as the damper sphere moves with the damper piston along the longitudinal axis of the damper cylinder; and
disposing one or more sealing ring assemblies, each sealing ring assembly disposed around the damper piston in the interior of the damper cylinder proximately to either the first piston opening or the second piston opening or both to prevent or reduce leakage of the pressurized granular material from the interior of the damper cylinder.

17. The method of claim 16, further comprising sizing the one or more sealing ring assemblies to tune the pressurized granular-material damper to a selected frequency.

18. The method of claim 16, wherein the granular material is sand or ball bearings.

19. The method of claim 16, wherein each of the one or more sealing ring assemblies comprises:
a cylindrical cap, wherein the cylindrical cap comprises a circular axial hole centered on the axis of the cylindrical cap, the circular axial hole having a piston portion having a first diameter to accommodate the damper piston, a sealing ring portion having a second diameter to accommodate one or more sealing rings, and a wiper portion having a third diameter to accommodate one or more high-speed rod wipers;
the one or more sealing rings; and
the one or more high-speed rod wipers.

20. The method of claim 19, wherein the cylindrical cap comprises steel.

21. The method of claim 19, wherein the one or more sealing rings comprise PTFE.

22. The method of claim 19, wherein the one or more high-speed rod wipers comprise PTFE.
